(19) United States
(12) Patent Application Publication
(10) Pub. No.: US 2024/0373789 A1
(43) Pub. Date: Nov. 14, 2024

(54) SYSTEM AND METHOD FOR WRAPPING AN AGRICULTURAL BALE

(71) Applicants: CNH Industrial Canada, Ltd., Saskatoon (CA); CNH Industrial America LLC, New Holland, PA (US)

(72) Inventors: Martin J. Roberge, Quebec (CA); Jonathan E. Ricketts, Coal Valley, IL (US)

(21) Appl. No.: 18/661,238

(22) Filed: May 10, 2024

Related U.S. Application Data
(60) Provisional application No. 63/501,719, filed on May 12, 2023.

(51) Int. Cl. A01F 15/07

(52) U.S. Cl. CPC A01F 15/071; A01F 2015/0745

(57) ABSTRACT

A bale wrap for an agricultural bale includes a first section formed from one or more natural materials. The bale wrap also includes a second section positioned downstream from the first section. The second section includes a water-resistant membrane configured to block water penetration into the agricultural bale while the bale wrap is wrapped around the agricultural bale, and the second section includes an adhesive configured to engage the first section while the bale wrap is wrapped around the agricultural bale. Furthermore, the bale wrap includes a third section positioned downstream from the second section. The third section is formed from one or more natural materials, and the third section includes an adhesive configured to engage the second section while the bale wrap is wrapped around the agricultural bale.

### BACKGROUND

The present disclosure relates generally to a system and method for wrapping an agricultural bale.

Agricultural balers are used to compress an agricultural product (e.g., cotton) into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale. The bale wrap may be formed from a natural material, such as cotton or hemp.

### BRIEF DESCRIPTION

In certain embodiments, a bale wrap for an agricultural bale includes a first section formed from one or more natural materials. The bale wrap also includes a second section positioned downstream from the first section. The second section includes a water-resistant membrane configured to block water penetration into the agricultural bale while the bale wrap is wrapped around the agricultural bale, and the second section includes an adhesive configured to engage the first section while the bale wrap is wrapped around the agricultural bale. Furthermore, the bale wrap includes a third section positioned downstream from the second section. The third section is formed from one or more natural materials, and the third section includes an adhesive configured to engage the second section while the bale wrap is wrapped around the agricultural bale.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having a bale wrapping system;

FIG. 2 is a schematic diagram of an embodiment of a bale wrapping system that may be employed within the agricultural system of FIG. 1;

FIG. 3 is a top view of an embodiment of a bale wrap that may be used within the bale wrapping system of FIG. 2;

FIG. 4 is a side view of an embodiment of a bale wrap that may be used within the bale wrapping system of FIG. 2; and

FIG. 5 is a view of a series of diagrammatical steps of an embodiment of a method of manufacturing a bale wrap that may be used within the bale wrapping system of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

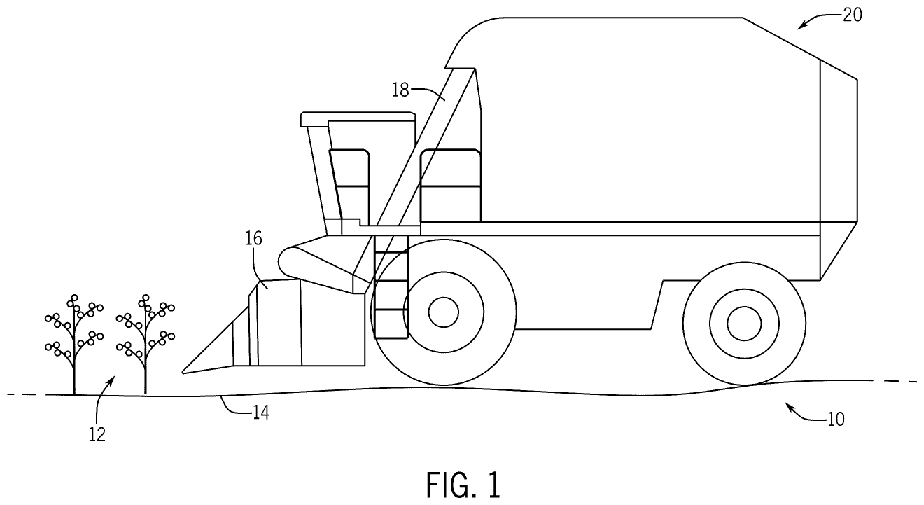

FIG. 1 is a side view of an embodiment of an agricultural system 10 (e.g., harvester) having a bale wrapping system. The agricultural system 10 is configured to harvest agricultural product 12 (e.g., cotton) from a field 14 and to form the agricultural product 12 into bales (e.g., agricultural bales). For example, the agricultural system 10 includes a header 16 having drums configured to harvest the agricultural product 12 from the field 14. Additionally, the agricultural system 10 includes an air-assisted conveying system 18 configured to move the agricultural product 12 from the drums of the header 16 to an accumulator. The agricultural product 12 may then be fed into a baler 20 (e.g., agricultural baler), such as via belt(s). The baler 20 is supported by and/or mounted within or on a chassis of the agricultural system 10. As discussed in detail below, the baler 20 may form the agricultural product 12 into round bales. However, in other embodiments, the baler 20 of the agricultural system 10 may form the agricultural product into square bales, polygonal bales, or bales of other suitable shape(s). As described in greater detail below, after forming the agricultural product 12 into a bale, the bale wrapping system of the agricultural system 10 wraps the bale with a bale wrap to secure the agricultural product 12 within the bale and to generally maintain a shape of the bale.

In certain embodiments, the bale wrap includes a first section formed from one or more natural materials, and the bale wrap includes a second section positioned downstream from the first section (e.g., relative to a direction of movement of the bale wrap toward the bale during the bale wrapping process). The second section includes a water-resistant membrane configured to block water penetration into the bale while the bale wrap is wrapped around the bale, and the second section includes an adhesive configured to engage the first section while the bale wrap is wrapped around the bale. Furthermore, the bale wrap includes a third section positioned downstream from the second section (e.g., relative to the direction of movement of the bale wrap toward the bale during the bale wrapping process). The third section includes an adhesive configured to engage the second section while the bale wrap is wrapped around the bale. The adhesive of the second section couples the second section to the first section, and the adhesive of the third section couples the third section to the second section, thereby coupling the bale wrap to the bale. Furthermore, the water-resistant membrane may protect the bale from environmental moisture (e.g., rain, dew, etc.). In addition, because the bale wrap is formed at least partially from natural materials (e.g., entirely from natural materials), waste may be reduced (e.g., as compare to a non-biodegradable plastic bale wrap).

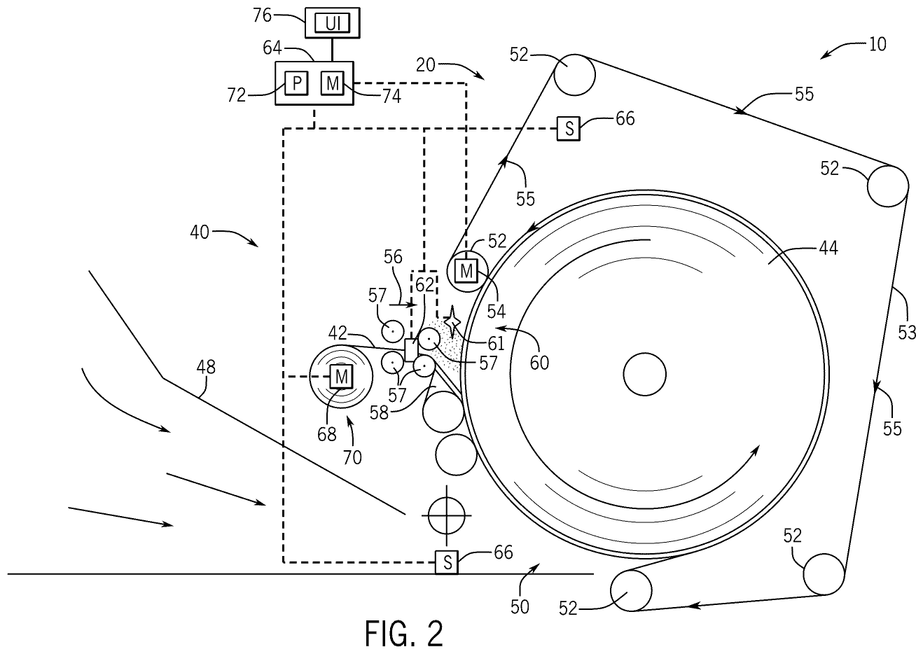

FIG. 2 is a schematic diagram of an embodiment of a bale wrapping system 40 that may be employed within the agricultural system 10 of FIG. 1. A bale wrap 42 is configured to wrap around a bale 44 (e.g., a bale of the agricultural product, an agricultural bale, etc.) formed by the baler 20 of the agricultural system 10. As cotton or another agricultural product is harvested, the agricultural product flows into an accumulator 48 (e.g., bale chamber) and/or a feeding system. For example, cotton may be blown by the air-assisted conveying system into the accumulator/bale chamber 48. The cotton is then fed into a cavity 50 of the baler 20. The baler 20 includes multiple rollers 52 that support and/or drive rotation of one or more belts 53. For example, one or more rollers 52 engage the belt(s) 53, which enable the belt(s) 53 to move along the pathway defined by the rollers 52 and the bale 44. One or more rollers are driven to rotate via a belt drive system 54 (e.g., including electric motor(s), hydraulic motor(s), pneumatic motor(s), etc.). The belt(s) 53 circulate around the path defined by the rollers 52 and the bale 44, as indicated by arrows 55. Movement of the belt(s) 53 captures agricultural product from the accumulator 48 and draws the agricultural product into the cavity 50, where the agricultural product is gradually built up to form the bale 44. As the agricultural product builds within the cavity 50, one or more of the rollers 52 may move radially outwardly to accommodate the increasing size of the bale 44.

Once the bale 44 reaches a desired size, the bale wrapping system 40 wraps the bale 44 with the bale wrap 42 to secure the agricultural product within the bale 44 and to generally maintain a shape of the bale 44, such as the round shape in the illustrated embodiment. In other embodiments, the shape of the bale may be rectangular, polygonal, or another suitable shape. As discussed in detail below, the bale wrap 42 includes a first section formed from one or more natural materials, and the bale wrap 42 includes a second section positioned downstream from the first section (e.g., relative to a direction of movement 56 of the bale wrap 42 toward the bale 44 during the bale wrapping process). The second section includes a water-resistant membrane configured to block water penetration into the bale 44 while the bale wrap 42 is wrapped around the bale, and the second section includes an adhesive configured to engage the first section while the bale wrap 42 is wrapped around the bale 44. The water-resistant membrane may be formed from an organic water-resistant material, a wax, a biodegradable plastic, etc. Furthermore, the bale wrap 42 includes a third section positioned downstream from the second section (e.g., relative to the direction of movement 56 of the bale wrap 42 toward the bale 44 during the bale wrapping process). The third section includes an adhesive configured to engage the second section while the bale wrap 42 is wrapped around the bale 44. The adhesive of the second section couples the second section to the first section, and the adhesive of the third section couples the third section to the second section, thereby coupling the bale wrap 42 to the bale 44. Furthermore, the water-resistant membrane may protect the bale from environmental moisture (e.g., rain, dew, etc.). In addition, because the bale wrap is formed at least partially from natural materials (e.g., entirely from natural materials), waste may be reduced (e.g., as compare to a non-biodegradable plastic bale wrap). The first, second, and third sections form a set of sections, and the bale wrap may include multiple sets of sections to facilitate wrapping multiple bales.

The bale wrap 42 is fed into contact with the bale 44 with one or more feed rollers 57 and over a wrap guide or wrap applicator 58 (e.g., duckbill). The wrap guide/wrap applicator 58 is configured to move (e.g., rotate) to direct the bale wrap 42 into contact with the bale 44. The bale wrap 42 is captured between the bale 44 and the belt(s) 53. Accordingly, rotation of the bale 44 draws the bale wrap 42 around the bale 44, thereby wrapping the bale 44.

To secure the bale wrap 42 around the bale 44, the bale wrapping system 40 includes an adhesive activation system 60. In certain embodiments, the adhesive activation system 60 includes one or more sprayers 61 that spray an activator (e.g., water) onto the adhesive of the bale wrap 42 to activate the adhesive. For example, in certain embodiments, the bale wrap 42 includes a protective film disposed over the adhesive of the second section and/or the adhesive of the third section. The protective film may be water-soluble. Accordingly, spraying water on the protective film dissolves the protective film, thereby activating the adhesive (e.g., the water may be sprayed along the entire bale wrap or just the second and third sections). Furthermore, in certain embodiments, the adhesive of the second section and/or the adhesive of the third section includes a powder disposed on and/or partially embedded in a base layer of the bale wrap 42, and the activator (e.g., water) is configured to activate the powdered adhesive (e.g., the activator may be sprayed along the entire bale wrap or just the second and third sections). In addition, in certain embodiments, the adhesive activation system includes a rotating brush, and the bale wrap 42 includes a protective film disposed over the adhesive of the second section and/or the adhesive of the third section. The rotating brush may engage the protective film, thereby removing the protective film, which activates the adhesive. Once the adhesive is activated, engagement of the adhesive of the second section with the first section couples the second section to the first section, and engagement of the adhesive of the third section with the second section couples the third section to the second section, thereby securing the bale wrap 42 around the bale 44.

In certain embodiments, after the bale wrap 42 is wrapped around the bale 44, the bale wrap 42 is cut with a cutter or cutting system 62 to separate additional bale wrap 42 (e.g., on a shaft of a bale wrap assembly) from the bale wrap 42 surrounding the bale 44. For example, the cutting system 62 may cut the bale wrap 42 between a downstream end (e.g., trailing end) of the third section of one set of sections and an upstream end (e.g., leading end) of the first section of a subsequent set of sections of the bale wrap 42. Alternatively, in certain embodiments, the bale wrap includes a weakened section positioned between the third section of one set of sections and the first section of a subsequent set of sections of the bale wrap 42. The weakened section is configured to break during the bale wrapping process, thereby separating additional bale wrap (e.g., on the shaft of the bale wrap assembly) from the bale wrap surrounding the bale. In such embodiments, the cutting system may be omitted.

In embodiments in which the baler 20 includes the cutting system 62, the cutting system 62 is configured to cut the bale wrap 42 between the downstream end (e.g., trailing end) of the third section of one set of sections and the upstream end (e.g., leading end) of the first section of a subsequent set of sections of the bale wrap 42. The cutting system 62 may include a cutting mechanism, an actuation assembly coupled to the cutting mechanism, and a track. The cutting mechanism may include a knife that engages the bale wrap 42 to cut the bale wrap 42. In other embodiments, the cutting mechanism may include other suitable mechanism(s) configured to cut the bale wrap (e.g., a rotary knife, a duckbill knife, a saw, a shear bar, etc.). In some embodiments, the actuation assembly is configured to move the cutting mechanism along a track to selectively drive the cutting mechanism into engagement with the bale wrap 42. In certain embodiments, the bale wrap 42 may have a partially pre-cut section (e.g., perforated section) positioned between the downstream end (e.g., trailing end) of the third section of one set of sections and the upstream end (e.g., leading end) of the first section of a subsequent set of sections to facilitate cutting the bale wrap 42 with the cutting system 62.

In certain embodiments, the agricultural system 10 includes a controller 64. The controller 64 may be configured to control rotation of the belt(s) 53 and/or a belt speed of the belt(s) 53. For example, in the illustrated embodiment, the controller 64 is communicatively coupled to the belt drive system 54, and the controller 64 is configured to control a rotation rate of one or more rollers 52 to control the belt speed of the belt(s) 53. The controller 64 may control the belt speed of the belt(s) 53 in response to feedback from one or more sensors 66. The sensor(s) 66 are communicatively coupled to the controller 64, and the sensor(s) 66 are configured to output sensor signal(s) indicative of a flow rate of agricultural material, size of the bale 44, other suitable parameter(s), or a combination thereof.

In some embodiments, upon determining the bale 44 has reached a desired size (e.g., based on feedback from the sensor(s) 66), the controller 64 may automatically activate a bale wrapping process. For example, the controller 64 may receive signal(s) from the sensor(s) 66 indicative of the size of the bale 44 (e.g., weight, diameter, circumference, etc.). Upon determining the bale 44 has reached a target size, the controller 64 may activate the bale wrapping system 40 to initiate the bale wrapping process. For example, in the illustrated embodiment, the controller 64 is communicatively coupled to a bale wrap shaft drive system 68 (e.g., including electric motor(s), hydraulic motor(s), pneumatic motor(s), etc.), which is coupled to a shaft of a bale wrap assembly 70 and configured to drive the shaft to rotate. While the bale wrap shaft drive system 68 is coupled to the shaft of the bale wrap assembly 70 in the illustrated embodiment, in other embodiments, the bale wrap shaft drive system may be coupled to one or more feed rollers 57 and configured to drive the feed roller(s) 57 to rotate, thereby driving the bale wrap 42 to move toward the bale 44, which drives the shaft of the bale wrap assembly 70 to rotate. The bale wrap assembly 70 includes the shaft and the bale wrap 42 disposed about the shaft. The controller 64 may activate the bale wrap shaft drive system 68 to begin feeding the bale wrap 42 toward the bale 44. In some embodiments, the wrap guide 58 (e.g., duckbill) may be actuated (e.g., rotated), which drives the bale wrap 42 into contact with the bale 44. As previously discussed, the bale wrap 42 is captured between the bale 44 and the belt(s) 53. Accordingly, rotation of the belt(s) 53 draws the bale wrap 42 around the bale 44.

In certain embodiments, the controller 64 is configured to control the adhesive activation system 60 based on feedback from the sensor(s) 66. For example, the sensor(s) 66 may be configured to output sensor signal(s) indicative of presence of the adhesive at the adhesive activation system 60. The controller 64 may receive the sensor signal(s) from the sensor(s) 66 and determine whether the adhesive is present at the adhesive activation system 60. In response to determining that the adhesive is positioned at the adhesive activation system, the controller 64 may activate the adhesive activation system 60 (e.g., activate the sprayer(s) 61 and/or activate the rotating brush) to activate the adhesive. Furthermore, in response to determining that the adhesive is not positioned at the adhesive activation system, the controller 64 may deactivate the adhesive activation system 60.

In embodiments in which the baler 20 includes the cutting system 62, the controller 64 is configured to control movement and operation of the cutting system 62. For example, the controller 64, which is communicatively coupled to the cutting system 62, may control engagement of a cutting mechanism of the cutting system 62 with the bale wrap 42, such that the cutting mechanism cuts the bale wrap 42. For example, the controller 64 may activate the cutting mechanism in response to determining that the interface between the third section of one set of sections and the first section of a subsequent set of sections is aligned with the cutting system 62. Once the bale wrap 42 is cut, the controller 64 controls the bale wrap shaft drive system 68 to terminate rotation of the shaft of the bale wrap assembly 70, and the controller controls the belt drive system 54 to continue rotation of the bale 44, such that the bale wrap 42 continues to rotate with the bale 44, thereby enabling the adhesive of the third section to engage the second section, which secures the bale wrap 42 around the bale 44.

Furthermore, in certain embodiments, the bale wrap 42 includes a weakened section positioned between the third section of one set of sections and the first section of a subsequent set of sections of the bale wrap 42. In such embodiments, the controller 64 may control the bale wrap shaft drive system 68 to separate additional bale wrap (e.g., on the shaft of the bale wrap assembly 70) from the bale wrap surrounding the bale. For example, the sensor(s) 66 may be configured to output sensor signal(s) indicative of the weakened section being positioned between the bale wrap assembly 70 and the bale 44. The controller 64 may be configured to receive the sensor signal(s) and determine that the weakened section is position between the bale wrap assembly and the bale. While the bale 44 continues to rotate, the controller may control the bale wrap shaft drive system 68 to terminate rotation of the shaft of the bale wrap assembly 70, thereby establishing a tension force at the weakened section sufficient to separate the additional bale wrap (e.g., on the shaft of the bale wrap assembly 70) from the bale wrap 42 surrounding the bale 44. Once the bale wrap is separated, the bale wrap 42 continues to rotate with the bale 44, thereby enabling the adhesive of the third section to engage the second section, which secures the bale wrap 42 around the bale 44.

Furthermore, in certain embodiments, the baler includes a braking system configured to control tension within the bale wrap. For example, the braking system may reduce the rotational speed of the shaft of the bale wrap assembly and/or the rotational speed of the feed rollers, thereby inducing tension within the bale wrap. Furthermore, in certain embodiments, the braking system may control application of force of a braking element (e.g., a brake, the wrap guide/applicator, etc.) against the bale wrap, thereby inducing tension within the bale wrap. In certain embodiments, the controller may control the braking system (e.g., alone or in combination with the bale wrap shaft drive system) to separate the additional bale wrap (e.g., on the shaft of the bale wrap assembly) from the bale wrap surrounding the bale. For example, the sensor(s) may be configured to output sensor signal(s) indicative of the weakened section being positioned between the bale wrap assembly and the bale. The controller may be configured to receive the sensor signal(s) and determine that the weakened section is position between the bale wrap assembly and the bale. While the bale continues to rotate, the controller may control the braking system (e.g., alone or in combination with the bale wrap shaft drive system) to establish a tension force at the weakened section sufficient to separate the additional bale wrap (e.g., on the shaft of the bale wrap assembly) from the bale wrap surrounding the bale. Once the bale wrap is separated, the bale wrap continues to rotate with the bale, thereby enabling the adhesive of the third section to engage the second section, which secures the bale wrap around the bale.

In certain embodiments, the controller 64 may control the adhesive activation system 60, the cutting system 62, the bale wrap shaft drive system 68, and the belt drive system 54 to control the bale wrapping process. For example, in response to the controller 64 determining that the bale 44 is in condition for wrapping, the controller 64 may control the belt drive system 54 to control the belt speed of the belt(s) 53, such that the belt(s) 53 reach a target belt speed for wrapping the bale 44. The target belt speed for wrapping the bale may be greater than or less than a target belt speed for bale formation. In certain embodiments, the belt speed may not be adjusted for wrapping the bale 44 (e.g., the target belt speed for wrapping the bale may be equal to the target belt speed for bale formation). The controller 64 may determine that the bale 44 is in condition for wrapping based on a weight of the bale 44 (e.g., based on feedback from the sensor(s) 66), a duration of the bale forming process, instructions from another controller (e.g., a harvester controller) to wrap the bale 44, based on a size of the bale 44 (e.g., based on feedback from the sensor(s) 66), other suitable parameter(s), or a combination thereof.

In response to determining the bale is in condition for wrapping, the controller 64 may control the bale wrap shaft drive system 68 to feed the bale wrap 42 toward the bale 44. The controller 64 may then output a signal to actuate the adhesive activation system 60 to activate the adhesive in response to determining the adhesive is positioned at the adhesive activation system 60. Furthermore, in response to determining the interface between the third section of one set of sections and the first section of a subsequent set of sections is aligned with the cutting system 62, the controller 64 may output a signal to the cutting system 62 to drive the cutting mechanism into engagement with the bale wrap 42, thereby cutting the bale wrap 42. Thereafter, the controller 64 may control the belt drive system 54 to stop rotation of the belt(s) 53. In certain embodiments, the controller 64 may control the belt drive system 54 to stop rotation of the belt(s) 53 in response to determining the interface between the third section of one set of sections and the first section of a subsequent set of sections is aligned with the cutting system 62. The controller 64 may then output a signal to the cutting system 62 to drive the cutting mechanism into engagement with the bale wrap 42, thereby cutting the bale wrap 42. Thereafter, the controller 64 may control the belt drive system 54 to restart rotation of the belt(s) 53 to enable the adhesive of the third section to engage the second section. The controller 64 may then control the belt drive system 54 to stop rotation of the belt(s) 53. Furthermore, in embodiments in which the bale wrap 42 includes a weakened section, in response to determining the weakened section is positioned between the bale wrap assembly and the bale, the controller 64 may control the braking system and/or the bale wrap shaft drive system 68 to establish a tension force at the weakened section sufficient to separate the additional bale wrap (e.g., on the shaft of the bale wrap assembly 70) from the bale wrap surrounding the bale 44. Thereafter, the controller 64 may control the belt drive system 54 to stop rotation of the belt(s) 53 (e.g., after the adhesive of the third section engages the second section). The wrapped bale 44 may then be ejected from the agricultural system 10.

In the illustrated embodiment, the controller 64 of the bale wrapping system 40 includes a processor 72 and a memory 74. The processor 72 (e.g., a microprocessor) may be used to execute software, such as software stored in the memory 74 for controlling the bale wrapping system 40 (e.g., for controlling rotation of the bale 44, the adhesive activation system 60, the cutting system 62, etc.). Moreover, the processor 72 may include multiple microprocessors, one or more “general-purpose” microprocessors, one or more special-purpose microprocessors, and/or one or more application specific integrated circuits (ASICS), or some combination thereof. For example, the processor 72 may include one or more reduced instruction set (RISC) or complex instruction set (CISC) processors.

The memory 74 may include a volatile memory, such as random-access memory (RAM), and/or a nonvolatile memory, such as read-only memory (ROM). The memory 74 may store a variety of information and may be used for various purposes. For example, the memory 74 may store processor-executable instructions (e.g., firmware or software) for the processor 72 to execute, such as instructions for controlling the bale wrapping system 40. In certain embodiments, the controller 64 may also include one or more storage devices and/or other suitable components. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the bale wrapping system 40), and any other suitable data. The processor 72 and/or the memory 74, and/or an additional processor and/or memory device, may be located in any suitable portion of the agricultural system 10.

Additionally, the bale wrapping system 40 includes a user interface 76 communicatively coupled to the controller 64. The user interface 76 may be configured to provide information to an operator (e.g., indicative of the rotation rate of the bale 44, the belt speed of the belt(s) 53, an amount of the bale wrap 42 remaining in the bale wrap assembly 70, a size of the bale 44, an amount of activator remaining, other suitable parameter(s), or a combination thereof). Additionally, the user interface 76 may be configured to enable operator interactions with the bale wrapping system 40, such as control of the adhesive activation system 60, control of the cutting system 62, control of the belt(s) 53, control of other parameter(s), or a combination thereof. For example, the user interface 76 may include a display and/or other user interaction device(s) (e.g., button(s)) configured to enable operator interactions.

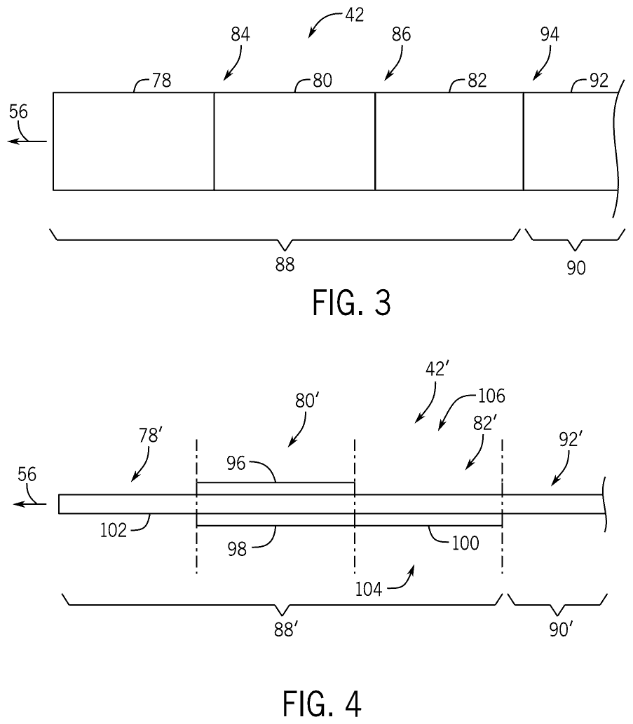

FIG. 3 is a top view of an embodiment of a bale wrap 42 that may be used within the bale wrapping system of FIG. 2. In the illustrated embodiment, the bale wrap 42 includes a first section 78 formed from one or more natural materials. The natural material(s) may include cotton, hemp, flax, other suitable natural material(s), or a combination thereof. For example, in certain embodiments, the first section 78 may be formed entirely from cotton, hemp, or flax.

The bale wrap 42 also includes a second section 80 positioned downstream (e.g., immediately downstream, directly downstream) from the first section 78 (e.g., relative to the direction of movement 56 of the bale wrap 42 toward the bale during the bale wrapping process). The second section 80 includes a water-resistant membrane configured to block water penetration into the bale while the bale wrap 42 is wrapped around the bale. Accordingly, the water-resistant membrane may protect the bale from environmental moisture (e.g., rain, dew, etc.). For example, the water-resistant membrane may be formed from an organic water-resistant material, a wax, a biodegradable plastic, etc. In addition, the second section 80 includes an adhesive configured to engage the first section while the bale wrap 42 is wrapped around the bale. As previously discussed, the adhesive of the second section 80 may be activated during the bale wrapping process. For example, activator (e.g., water) may be sprayed onto the adhesive of the second section 80 while the bale wrap 42 is wrapping around the bale, thereby activating the adhesive. Alternatively, a protective film covering the adhesive of the second section 80 may be removed (e.g., via a rotating brush) while the bale wrap 42 is wrapping around the bale, thereby activating the adhesive. Once the adhesive is activated, engagement of the adhesive of the second section 80 with the first section 78 couples the second section 80 to the first section 78, thereby partially securing the bale wrap 42 around the bale.

Furthermore, the bale wrap 42 includes a third section 82 positioned downstream (e.g., directly downstream, immediately downstream) from the second section 80 (e.g., relative to the direction of movement 56 of the bale wrap 42 toward the bale during the bale wrapping process). The third section 82 is formed from one or more natural materials. The natural material(s) may include cotton, hemp, flax, other suitable natural material(s), or a combination thereof. In addition, the third section 82 includes an adhesive configured to engage the second section 80 while the bale wrap 42 is wrapped around the bale. As previously discussed, the adhesive of the third section 82 may be activated during the bale wrapping process. For example, activator (e.g., water) may be sprayed onto the adhesive of the third section 82 while the bale wrap 42 is wrapping around the bale, thereby activating the adhesive. Alternatively, a protective film covering the adhesive of the third section 82 may be removed (e.g., via a rotating brush) while the bale wrap 42 is wrapping around the bale, thereby activating the adhesive. Once the adhesive is activated, engagement of the adhesive of the third section 82 with the second section 80 couples the third section 82 to the second section 80, thereby securing the bale wrap 42 around the bale.

In the illustrated embodiment, the first section 78 is coupled to the second section 80 by a stitched connection 84 (e.g., first stitched connection), and the second section 80 is coupled to the third section 82 by a stitched connection 86 (e.g., second stitched connection). The stitched connections enable the bale wrap 42 to be wrapped around the bale during the bale wrapping process and to secure the agricultural product within the bale after the wrapping process is complete. In addition, because the sections are coupled to one another by stitched connections, the sections may be formed from different materials. For example, the first and third sections may be formed from one or more natural materials, and the second section may be formed from an organic water-resistant material. While the sections of each pair of adjacent sections are coupled to one another by a stitched connection in the illustrated embodiment, in other embodiments, the sections of at least one pair of adjacent sections may be coupled to one another by another suitable type of connection (e.g., an adhesive connection, a stapled connection, etc.).

While the bale wrap is formed by sections coupled to one another in the illustrated embodiment, in other embodiments, the bale wrap may be formed by other suitable elements/techniques. For example, in certain embodiments, the bale wrap may include a base layer forming at least a portion of the first section, a portion of the second section, and a portion of the third section. The base layer may be formed from one or more natural materials. For example, in certain embodiments, the base layer may be formed entirely from cotton, hemp, or flax. The water-resistant membrane of the second section is coupled to the base layer. In addition, the adhesive of the third section is disposed on and/or partially in the base layer. Furthermore, in certain embodiments, the adhesive of the second section may be positioned on an opposite side of the base layer from the water-resistant membrane. Alternatively, in certain embodiments, the adhesive of the second section may be positioned on an opposite side of the water-resistant membrane from the base layer. As previously discussed, the adhesive of the second section is configured to engage the first section while the bale wrap is wrapped around the bale, and the adhesive of the third section is configured to engage the second section while the bale wrap is wrapped around the bale, thereby securing the bale wrap to the bale.

In the illustrated embodiment, the first, second, and third sections form a first set of sections 88. In addition, the bale wrap 42 includes a second set of sections 90 having another first section 92, second section, and third section. In certain embodiments, the structure of the first section 92 of the second set of sections 90 may be the same as the structure of the first section 78 of the first set of sections 88, the structure of the second section of the second set of sections 90 may be the same as the structure of the second section 80 of the first set of sections 88, and the structure of the third section of the second set of sections 90 may be the same as the structure of the third section 82 of the first set of sections 88. In the illustrated embodiment, the third section 82 of the first set of sections 88 is coupled to the first section 92 of the second set of sections 90 by a stitched connection 94, thereby forming a continuous bale wrap 42. In other embodiments, the third section of the first set of sections may be coupled to the first section of the second set of sections by another suitable type of connection (e.g., an adhesive connection, a stapled connection, etc.). Furthermore, in certain embodiments, the bale wrap 42 includes a weakened section positioned between the third section 82 of the first set of sections 88 and the first section 92 of the second set of sections 90. As previously discussed, the weakened section is configured to break during the bale wrapping process, thereby separating the second set of sections 90 (e.g., additional bale wrap on the shaft of the bale wrap assembly) from the first set of sections 88 (e.g., bale wrap surrounding the bale).

In certain embodiments, the first section 78 includes an adhesive configured to be positioned between the one or more natural materials of the first section 78 and the bale while the bale wrap 42 is wrapped around the bale. In certain embodiments, the adhesive of the first section 78 may not be activated during the bale wrapping process, such that the adhesive does not couple the first section to the bale while the bale wrap 42 is wrapped around the bale. The adhesive may be included to facilitate the bale wrap manufacturing process. For example, in embodiments in which the bale wrap is formed from sections coupled to one another, including the adhesive in the first section enables the first section to be structurally the same as the third section, thereby reducing manufacturing complexity (e.g., as compared to manufacturing first and third sections having different structures/configurations). Furthermore, in embodiments in which the bale wrap is formed by applying adhesive to a base layer, including the adhesive in the first section enables the adhesive to be applied to an entirety of the base layer, thereby reducing manufacturing complexity (e.g., as compared to applying the adhesive to only the second and third sections). While a first section having a non-activated adhesive is disclosed above, in certain embodiments, the adhesive of the first section may be activated. In addition, while a first section having an adhesive is disclosed above, in certain embodiments, the first section may not include an adhesive.

In certain embodiments, the length of each section (e.g., relative to the direction of movement 56 of the bale wrap 42 toward the bale during the bale wrapping process) may be particularly selected based on the peripheral extent (e.g., circumference) of the bale. For example, in certain embodiments, the length of each section may be substantially equal to the peripheral extent (e.g., circumference) of the bale. Accordingly, each section may completely surround the bale without overlapping itself, and each set of sections may completely surround the bale with three layers (i.e., one for each section). As such, positioning the weakened section between the third section of one set of sections and the first section of a subsequent set of sections enables the bale wrap to surround each bale with a respective set of sections. By way of example, for a bale having an 8-foot (e.g., 2.44 m) diameter, the length of each section may be about 25.1 feet (e.g., 7.7 m). In certain embodiments, a bale wrap having 25.1-foot (e.g., 7.7 m) sections may be used for a bale having a smaller diameter (e.g., 7 feet/2.13 m, 6 feet/1.83 m, 5 feet/1.52 m, 4 feet/1.22 m, 3 feet/0.91 m, etc.). In such embodiments, each section may extend around the bale more than one complete wrap. Furthermore, in certain embodiments, at least one section (e.g., the first section and/or the third section) may have a length greater than the peripheral extent (e.g., circumference) of the bale to enable the section to wrap around the bale one entire wrap and a portion of a second wrap. For example, at least one section (e.g., the first section and/or the third section) may have a length that is 1 percent, 2 percent, 5 percent, 7 percent, 10 percent, or 15 percent greater than the peripheral extent (e.g., circumference) of the bale.

FIG. 4 is a side view of an embodiment of a bale wrap 42′ that may be used within the bale wrapping system of FIG. 2. As previously discussed, the bale wrap 42′ includes a first section 78′ formed from one or more natural materials. In addition, the bale wrap 42′ includes a second section 80′ positioned downstream from the first section 78′ (e.g., relative to the direction of movement 56 of the bale wrap 42′ toward the bale during the bale wrapping process). The second section 80′ includes a water-resistant membrane 96 configured to block water penetration into the bale while the bale wrap 42′ is wrapped around the bale. The second section 80′ also includes an adhesive 98 configured to engage the first section 78′ while the bale wrap 42′ is wrapped around the bale. Furthermore, the bale wrap 42′ includes a third section 82′ positioned downstream from the second section 80′ (e.g., relative to the direction of movement 56 of the bale wrap 42′ toward the bale during the bale wrapping process). The third section 82′ is formed from one or more natural materials, and the third section 82′ includes an adhesive 100 configured to engage the second section 80′ while the bale wrap 42′ is wrapped around the bale.

In the illustrated embodiment, the bale wrap 42′ includes a base layer 102 forming at least a portion of the first section 78′, a portion of the second section 80′, and a portion of the third section 82′. The base layer 102 may be formed from one or more natural materials. For example, in certain embodiments, the base layer 102 may be formed entirely from cotton, hemp, or flax. The water-resistant membrane 96 of the second section 80′ is coupled to the base layer 102. As previously discussed, the water-resistant membrane may be formed from an organic water-resistant material, a wax, a biodegradable plastic, etc. In addition, the adhesive 100 of the third section 82′ is disposed on and/or partially in the base layer 102. As illustrated, the adhesive 100 of the third section 82′ is positioned on an inner side 104 of the bale wrap 42′ to enable the adhesive 100 of the third section 82′ to engage the second section 80′ while the bale wrap 42′ is wrapped around the bale. Furthermore, in the illustrated embodiment, the adhesive 98 of the second section 80′ is positioned on an opposite side of the base layer 102 from the water-resistant membrane 96. As illustrated, the water-resistant membrane 96 is positioned on an outer side 106 of the bale wrap 42′, and the adhesive 98 of the second section 80′ is positioned on the inner side 104 of the bale wrap 42′ to enable the adhesive 98 to engage the first section 78′ while the bale wrap 42′ is wrapped around the bale. For example, the adhesive 98 of the second section 80′ may be disposed on and/or partially in the base layer 102. However, in other embodiments, the adhesive of the second section may be positioned on an opposite side of the water-resistant membrane from the base layer, such that the adhesive of the second section is positioned on the inner side of the bale wrap and the water-resistant membrane is positioned between the adhesive and the base layer. For example, the adhesive of the second section may be disposed on and/or partially in the water-resistant membrane. As previously discussed, the adhesive 98 of the second section 80′ is configured to engage the first section 78′ while the bale wrap 42′ is wrapped around the bale, and the adhesive 100 of the third section 82′ is configured to engage the second section 80′ while the bale wrap 42′ is wrapped around the bale, thereby securing the bale wrap 42′ to the bale.

While the first section does not include an adhesive in the illustrated embodiment, in certain embodiments, the first section may include an adhesive configured to be positioned between the base layer and the bale while the bale wrap is wrapped around the bale. For example, the adhesive of the first section may be positioned on the inner side of the bale wrap. In certain embodiments, the adhesive of the first section may not be activated during the bale wrapping process, such that the adhesive does not couple the first section to the bale while the bale wrap is wrapped around the bale. The adhesive may be included to facilitate the bale wrap manufacturing process. For example, including the adhesive in the first section enables the adhesive to be applied to an entirety of the base layer, thereby reducing manufacturing complexity (e.g., as compared to applying the adhesive to only the second and third sections). While a first section having a non-activated adhesive is disclosed above, in certain embodiments, the adhesive of the first section may be activated.

As previously discussed, the first, second, and third sections form a first set of sections 88′. In addition, the bale wrap 42′ includes a second set of sections 90′ having another first section 92′, second section, and third section. In certain embodiments, the structure of the first section 92′ of the second set of sections 90′ may be the same as the structure of the first section 78′ of the first set of sections 88′, the structure of the second section of the second set of sections 90′ may be the same as the structure of the second section 80′ of the first set of sections 88′, and the structure of the third section of the second set of sections 90′ may be the same as the structure of the third section 82′ of the first set of sections 88′. In certain embodiments, the third section 82′ of the first set of sections 88′ may be coupled to the first section 92′ of the second set of sections 90′ by a suitable connection (e.g., a stitched connection, an adhesive connection, a stapled connection, etc.), thereby forming a continuous bale wrap 42′. Furthermore, in certain embodiments, the bale wrap 42′ may include a weakened section positioned between the third section 82′ of the first set of sections 88′ and the first section 92′ of the second set of sections 90′. As previously discussed, the weakened section is configured to break during the bale wrapping process, thereby separating the second set of sections 90′ (e.g., additional bale wrap on the shaft of the bale wrap assembly) from the first set of sections 88′ (e.g., bale wrap surrounding the bale).

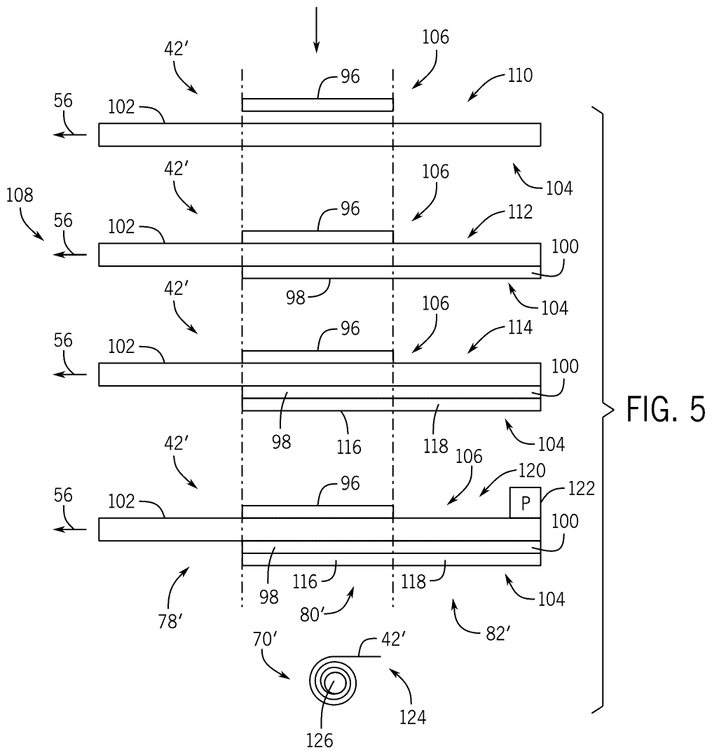

FIG. 5 is a view of a series of diagrammatical steps of an embodiment of a method 108 of manufacturing a bale wrap 42′ that may be used within the bale wrapping system of FIG. 2. In a first step 110 of the method 108 (e.g., at a first manufacturing station), the water-resistant membrane 96 is coupled to the base layer 102 to form the first section 78′ upstream of the water-resistant membrane (e.g., relative to the direction of movement 56 of the bale wrap 42′ toward the bale during the bale wrapping process), the second section 80′ at the water-resistant membrane 96, and the third section 82′ downstream from the water-resistant membrane 96 (e.g., relative to the direction of movement 56 of the bale wrap 42′ toward the bale during the bale wrapping process). In the illustrated embodiment, the water-resistant membrane 96 is coupled to the base layer 102, such that the water-resistant membrane 96 is positioned on the outer side 106 of the bale wrap 42′. As previously discussed, the base layer 102 is formed from one or more natural materials. For example, in certain embodiments, the base layer 102 may be formed entirely from cotton, hemp, or flax. Furthermore, as previously discussed, the water-resistant membrane 96 is configured to block water penetration into the bale while the bale wrap 42′ is wrapped around the bale. For example, the water-resistant membrane 96 may be formed from an organic water-resistant material, a wax, a biodegradable plastic, etc. The water-resistant membrane 96 may be coupled to the base layer 102 via any suitable type(s) of connection(s), such as an adhesive connection, a stitched connection, a stapled connection, other suitable type(s) of connection(s), or a combination thereof.

In a second step 112 of the method 108 (e.g., at a second manufacturing station), the adhesive 98 is applied to the base layer 102 at the second section 80′, and the adhesive 100 is applied to the base layer 102 at the third section 82′. In the illustrated embodiment, the adhesive 98 is applied to the base layer 102 at the second section 80′, such that the adhesive 98 is positioned on the inner side 104 of the bale wrap 42′ to enable the adhesive 98 of the second section 80′ to engage the first section 78′ while the bale wrap 42′ is wrapped around the bale. In addition, the adhesive 100 is applied to the base layer 102 at the third section 82′, such that the adhesive 100 is positioned on the inner side 104 of the bale wrap 42′ to enable the adhesive 100 of the third section 82′ to engage the second section 80′ while the bale wrap 42′ is wrapped around the bale. In certain embodiments, the adhesive may be applied as a liquid that engages and bonds to the base layer. Furthermore, in certain embodiments, the adhesive may be applied as a powder that becomes embedded in the base layer. In certain embodiments, the adhesive may be applied continuously along the base layer at the second section and at the third section.

In a third step 114 of the method 108 (e.g., at a third manufacturing station), a protective film 116 is applied to the adhesive 98 of the second section 80′, and a protective film 118 is applied to the adhesive 100 of the third section 82′. For example, the protective film may be applied continuously along the adhesive of the first and second sections (e.g., from a roll of protective film) as a single element to form the protective film 116/118. In certain embodiments, the protective film may be water-soluble. Accordingly, during the bale wrapping process, the adhesive activation system may spray water onto the protective film to dissolve the protective film, thereby activating the adhesive. Furthermore, in certain embodiments, the adhesive activation system includes a rotating brush configured to engage the protective film, thereby removing the protective film, which activates the adhesive. Once the adhesive is activated, engagement of the adhesive 98 of the second section 80′ with the first section 78′ couples the second section 80′ to the first section 78′, and engagement of the adhesive 100 of the third section 82′ with the second section 80′ couples the third section 82′ to the second section 80′, thereby securing the bale wrap 42′ around the bale. In certain embodiments, the step 114 may be omitted, such that the protective film is omitted. In such embodiments, the adhesive may be activated by spraying an activator (e.g., water) onto the adhesive during the bale wrapping process.

In a fourth step 120 of the method 108 (e.g., at a fourth manufacturing station), identification information is printed onto the bale wrap 42′, a sticker having identification information is applied to the bale wrap 42′, a radio frequency identification (RFID) tag is coupled to the bale wrap 42′, or a combination thereof. For example, in certain embodiments, a print head 122 may print the identification information onto the outer side 106 of the bale wrap 42′. Furthermore, in certain embodiments, an applicator may apply a sticker having the identification information onto the outer side 106 of the bale wrap 42′. In addition, in certain embodiments, an applicator may couple an RFID tag to the bale wrap 42′.

The identification information/RFID tag may facilitate identification and tracking of the wrapped bale. For example, in certain embodiments, the identification information may include a machine-readable code, such as a bar code or a quick response (QR) code. Accordingly, the identification information may enable an automated system to identify the wrapped bale while the wrapped bale is in the field and while the wrapped bale is being transported, thereby facilitating tracking of the wrapped bale. Furthermore, in certain embodiments, the identification information may include text (e.g., alone or in combination with the machine-readable code) that includes an identification code (e.g., unique to each wrapped bale), field location information (e.g., determined by the controller via feedback from a spatial locating device, such as a global positioning system receiver, when the wrapped bale is deposited on the field), the date and time of harvest, weather information, bale moisture at baling, a bale weight, planting information (e.g., planting date/time, fertilizer application date/time, etc.), baler operator information, fertilizer information, yield information, seed type, other suitable information, or a combination thereof. In addition, in certain embodiments, an identification code (e.g., unique to each wrapped bale), field location information (e.g., determined by the controller via feedback from a spatial locating device, such as a global positioning system receiver, when the wrapped bale is deposited on the field), the date and time of harvest, weather information, bale moisture at baling, a bale weight, planting information (e.g., planting date/time, fertilizer application date/time, etc.), baler operator information, fertilizer information, yield information, seed type, other suitable information, or a combination thereof, may be associated with the machine-readable code. For example, the controller may output the machine-readable code (e.g., number corresponding to the machine-readable code) and the data associated with the machine-readable code to a remote server, which may store the machine-readable code (e.g., number corresponding to the machine readable code) and the data associated with the machine-readable code. Furthermore, with regard to the RFID tag, an identification code (e.g., unique to each wrapped bale), field location information (e.g., determined by the controller via feedback from a spatial locating device, such as a global positioning system receiver, when the wrapped bale is deposited on the field), the date and time of harvest, weather information, bale moisture at baling, a bale weight, planting information (e.g., planting date/time, fertilizer application date/time, etc.), baler operator information, fertilizer information, yield information, seed type, other suitable information, or a combination thereof, may be associated with RFID tag information corresponding to the RFID tag. For example, the controller may output the RFID tag information and the data associated with the RFID tag information to a remote server, which may store the RFID tag information and the data associated with the RFID tag information.

In a fifth step 124 of the method 108 (e.g., at a fifth manufacturing station), the bale wrap 42′ is wrapped around a shaft 126 of the bale wrap assembly 70′, thereby forming the bale wrap assembly 70′. The steps of the method 108 may be performed in the illustrated order or in any other suitable order. For example, at least two steps of the method may be performed concurrently (e.g., the adhesive and the water-resistant membrane may be applied concurrently, the adhesive and the protective film may be applied concurrently, etc.). Furthermore, in certain embodiments, one or more steps of the method 108 may be omitted (e.g., the step of applying the protective film may be omitted, the step of printing the identification information/applying the sticker having the identification information/coupling the RFID tag to the bale wrap may be omitted, etc.).

While the water-resistant membrane 96 is positioned on the outer side 106 of the bale wrap 42′ in the illustrated embodiment, in other embodiments, the adhesive of the second section may be positioned on an opposite side of the water-resistant membrane from the base layer, such that the adhesive of the second section is positioned on the inner side of the bale wrap and the water-resistant membrane is positioned between the adhesive and the base layer. For example, the adhesive of the second section may be disposed on and/or partially in the water-resistant membrane. Furthermore, while the first section does not include an adhesive in the illustrated embodiment, in certain embodiments, the first section may include an adhesive configured to be positioned between the base layer and the bale while the bale wrap is wrapped around the bale. For example, the adhesive of the first section may be positioned on the inner side of the bale wrap. In certain embodiments, the adhesive of the first section may not be activated during the bale wrapping process, such that the adhesive does not couple the first section to the bale while the bale wrap is wrapped around the bale. The adhesive may be included to facilitate the bale wrap manufacturing process. For example, including the adhesive in the first section enables the adhesive to be applied (e.g., continuously applied) to an entirety of the base layer, thereby reducing manufacturing complexity (e.g., as compared to applying the adhesive to only the second and third sections). In addition, in embodiments in which the first section includes the adhesive and the protective film is applied to the adhesive of the second and third sections, the protective film may be applied to the adhesive of the first section as well. Accordingly, the protective film may be applied to the entirety of the adhesive along the bale wrap, thereby reducing manufacturing complexity (e.g., as compared to applying the protective film only at the second and third sections). While a first section having a non-activated adhesive is disclosed above, in certain embodiments, the adhesive of the first section may be activated.

While each set of sections of the bale wrap includes three sections in the embodiments disclosed above, in certain embodiments, at least one set of sections (e.g., each set of sections of the bale wrap) may include more or fewer sections (e.g., 2, 4, 5, 6, or more). Furthermore, while the adhesive is positioned on the inner side of the bale wrap in the embodiments disclosed above, in certain embodiments, the adhesive may be positioned on the outer side of the bale wrap (e.g., alone or in combination with the inner side). For example, in certain embodiments, the first section may include an adhesive configured to engage the second section while the bale wrap is wrapped around the bale, and the second section may include an adhesive configured to engage the third section while the bale wrap is wrapped around the bale, thereby securing the bale wrap to the bale. In embodiments in which the adhesive is positioned on the outer side of the bale wrap, the adhesive activation system may be positioned to activate the adhesive on the outer side of the bale wrap.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A bale wrap for an agricultural bale, comprising:
a first section formed from one or more natural materials;
a second section positioned downstream from the first section, wherein the second section comprises a water-resistant membrane configured to block water penetration into the agricultural bale while the bale wrap is wrapped around the agricultural bale, and the second section comprises an adhesive configured to engage the first section while the bale wrap is wrapped around the agricultural bale; and
a third section positioned downstream from the second section, wherein the third section is formed from one or more natural materials, and the third section comprises an adhesive configured to engage the second section while the bale wrap is wrapped around the agricultural bale.

2. The bale wrap of claim 1, wherein the one or more natural materials of the first section comprise cotton, hemp, flax, or a combination thereof;
the one or more natural materials of the third section comprise cotton, hemp, flax, or a combination thereof; or
a combination thereof.

3. The bale wrap of claim 1, wherein the first section is coupled to the second section by a first stitched connection, and the second section is coupled to the third section by a second stitched connection.

4. The bale wrap of claim 1, wherein the bale wrap comprises a base layer forming at least a portion of the first section, a portion of the second section, and a portion of the third section, the water-resistant membrane of the second section is coupled to the base layer, and the adhesive of the third section is disposed on the base layer, partially in the base layer, or a combination thereof.

5. The bale wrap of claim 4, wherein the base layer is formed entirely from cotton, hemp, or flax.

6. The bale wrap of claim 4, wherein the water-resistant membrane of the second section is positioned on an opposite side of the base layer from the adhesive of the second section; or
the adhesive of the second section is positioned on an opposite side of the water-resistant membrane from the base layer.

7. The bale wrap of claim 1, wherein the first, second, and third sections form a first set of sections, the bale wrap comprises a second set of sections, and the first and second sets of sections are coupled to one another by a weakened section configured to break during a process of wrapping the agricultural bale with the bale wrap.

8. The bale wrap of claim 1, wherein the first section comprises an adhesive configured to be positioned between the one or more natural materials of the first section and the agricultural bale while the bale wrap is wrapped around the agricultural bale.

9. A method for wrapping an agricultural bale, comprising:
wrapping the agricultural bale with a bale wrap comprising:
a first section formed from one or more natural materials;
a second section positioned downstream from the first section, wherein the second section comprises a water-resistant membrane configured to block water penetration into the agricultural bale while the bale wrap is wrapped around the agricultural bale, and the second section comprises an adhesive configured to engage the first section while the bale wrap is wrapped around the agricultural bale; and
a third section positioned downstream from the second section, wherein the third section is formed from one or more natural materials, and the third section comprises an adhesive configured to engage the second section while the bale wrap is wrapped around the agricultural bale.

10. The method of claim 9, comprising spraying an activator onto the adhesive of the second section and the adhesive of the third section while wrapping the agricultural bale with the bale wrap to activate the adhesive of the second section and the adhesive of the third section.

11. The method of claim 9, comprising removing a protective film from the adhesive of the second section and removing the protective film from the adhesive of the third section while wrapping the agricultural bale with the bale wrap.

12. The method of claim 9, comprising cutting the bale wrap at a downstream end of the third section.

13. The method of claim 9, comprising pulling a first set of sections apart from a second set of sections at a weakened section of the bale wrap, wherein the first, second, and third sections form the first set of sections, and the first and second sets of sections are coupled to one another by the weakened section.

14. The method of claim 9, wherein the first section is coupled to the second section by a stitched connection, and the second section is coupled to the third section by a stitched connection.

15. The method of claim 9, wherein the one or more natural materials of the first section comprise cotton, hemp, flax, or a combination thereof;
the one or more natural materials of the third section comprise cotton, hemp, flax, or a combination thereof; or
a combination thereof.

16. A method of manufacturing a bale wrap for an agricultural bale, comprising:
coupling a water-resistant membrane to a base layer to form a first section upstream of the water-resistant membrane, a second section at the water-resistant membrane, and a third section downstream from the water-resistant membrane, wherein the base layer is formed from one or more natural materials, and the water-resistant membrane is configured to block water penetration into the agricultural bale while the bale wrap is wrapped around the agricultural bale; and
applying an adhesive to the base layer at the second section and at the third section, such that the adhesive of the second section is configured to engage the first section while the bale wrap is wrapped around the agricultural bale, and the adhesive of the third section is configured to engage the second section while the bale wrap is wrapped around the agricultural bale.

17. The method of claim 16, comprising applying a protective film onto the adhesive.

18. The method of claim 16, comprising printing identification information onto the bale wrap, applying a sticker having the identification information onto the bale wrap, coupling a radio frequency identification (RFID) tag to the bale wrap, or a combination thereof.

19. The method of claim 16, comprising wrapping the bale wrap around a shaft.

20. The method of claim 16, wherein the base layer is formed entirely from cotton, hemp, or flax.
